(19) United States
(12) Patent Application Publication
(10) Pub. No.: US 2012/0181150 A1
(43) Pub. Date: Jul. 19, 2012

(54) METHOD FOR CARRYING OUT A BELT RUN CORRECTION FOR A CONVEYOR BELT OF A PRESS, AND PRESS HAVING A CONVEYOR BELT AND BELT RUN CORRECTION

(75) Inventor: Norbert Damm, Karlsdorf-Neuthard (DE)

(73) Assignee: ROBERT BURKLE GMBH, Freudenstadt (DE)

(21) Appl. No.: 13/347,049

(22) Filed: Jan. 10, 2012

(30) Foreign Application Priority Data
Jan. 14, 2011 (DE) 102011008650.1

(51) Int. Cl. B65G 23/44

(52) U.S. Cl. 198/617; 198/813

(57) ABSTRACT

A method for carrying out a belt run correction for a conveyor belt 5 of a press having at least one press layer 1, 1′, 1″, 1′″. This layer includes a lower press plate 3 and an upper press plate 4 that can be moved relative to one another in order to open and close the press layer 1, a conveyor belt 5 that runs around the lower press plate 3 for conveying a workpiece into and out of the press layer 1, and at least one deflection roller 7, 8 for the conveyor belt 5, situated at an end face of the lower press plate 3, that deflects the conveyor belt 5 from the upper side to the lower side of the lower press plate 3 and vice versa. A tension device 6 for tensions and relaxes the conveyor belt 5, with the deflection roller 7 being movable by the tensioning device 6 relative to the lower press plate 3, and being moved axially as needed in order to carry out the belt run correction. A press is provided having a corresponding design.

### CROSS-REFERENCE TO RELATED APPLICATIONS

This application claims the benefit of German Patent Application No. 10 2011 008 650.1, filed Jan. 14, 2011, which is incorporated herein by reference as if fully set forth.

### BACKGROUND

The present invention relates to a method for carrying out a belt run correction for a conveyor belt of a press having at least one press layer. The present invention further relates to a press having at least one press layer.

A press of the present type, in which the method of the present type is carried out, includes at least one press layer having a lower press plate and an upper press plate that can be moved relative to one another in order to open and close the press layer. In order to convey a workpiece that is to be processed into and out of the press layer, a conveyor belt runs around the lower press plate. At least one end face of the lower press plate, at least one respective deflection roller is provided, which can be a merely entrained idle roller or a drive roller, and which deflects the conveyor belt from the upper side to the lower side of the lower press plate and vice versa. At least one deflection roller is provided with a tensioning device in order to tension and relax the conveyor belt. If for example a deflection roller is provided at each end face of the lower press plate, it is sufficient for only one of these two deflection rollers to be equipped with such a tensioning device. The tensioning and relaxing of the conveyor belt here takes place in such a way that the deflection roller provided with the tensioning device can be moved relative to the lower press plate by means of the tensioning device, i.e. is movable towards it and away from it, so that the conveyor belt running around it is tensioned and relaxed. The relaxing of the conveyor belt after termination of a transport movement ensures that the processing of the workpiece in the press, which necessarily remains lying on the conveyor belt during the processing, is not impaired by a tensioning of the conveyor belt. Such a press, having a conveyor belt, deflection roller, and tension device in a multi-layer realization, is described for example in DE-A-10 2007 025 380.

As with all conveyor belts, in a press of the present type it is not unproblematic to keep the conveyor belt in its track, because during operation the conveyor belt has a tendency to move out of the track transverse to its running direction, i.e. horizontally to the right or to the left, seen in the running direction. Such a horizontal displacement of the conveyor belt must be prevented or corrected from time to time in order to prevent an otherwise unavoidable disturbance in the operation of the conveyor belt.

In standard conveying devices having conveyor belts running around drive and guide rollers, it is standard for these rollers to be made barrel-shaped, or in the shape of a double cone, in order to bring about a self-centering of the conveyor belt in its track during the running operation of the belt. In addition, positive-fit guide elements, such as a V-ribbed belt attachment on the inner side of the conveyor belt that runs in grooves of the drive and deflection rollers, are known with the aid of which the conveyor belt can be prevented from moving out of its track.

However, in a press of the present type conveyor belts are mostly used that are made relatively broad and short, i.e. such that the ratio of the distance between the two deflection axes to the width of the conveyor belt is less than approximately 2:1. In such relatively short and broad transport belts, the above-noted conventional measures for belt run correction mostly yield unsatisfactory results, resulting in frequent disturbances of operation. Therefore, in presses of the present type it has become standard to use an active belt run control system. This system acts in a targeted manner on the tensioning device of the conveyor belt in order to correct or compensate a movement, or a recognized movement tendency, of the belt during the transport movement, using an asymmetrical tensioning (stronger on the left side than on the right side, or vice versa).

However, such an active belt run control system is expensive. In addition, for a preferred use of a press of the present type, namely the lamination of essentially plate-shaped workpieces under the action of pressure and heat in a vacuum chamber formed by one-part or multi-part seals between the lower press plate and the upper press plate, woven belts having little flexibility, preferably made of aramid fibers, are used as conveyor belts, which have to be additionally coated with PTFE due to the highly adhesive glue used during the lamination. For such conveyor belts, an active belt controlling system has to apply relatively high positioning forces in order to keep the conveyor belt in its track. This increases the mechanical stress both on the tensioning device and on the conveyor belt itself, resulting finally in increased wear.

In the case of such inflexible conveyor belts requiring high positioning forces during active belt controlling, there is moreover the danger of formation of folds in the conveyor belt, because the transverse forces applied to the belt for the run correction can exceed the local frictional forces between the conveyor belt and the drive roller or idle roller. Relatively broad conveyor belts are particularly susceptible to this additional risk.

If a press of the present type is constructed as a multi-layer press, additional difficulties result from the use of a conventional active belt run control system. This is because in a multi-layer press the upper press plate of a press layer is at the same time the lower press plate of the next-higher press layer. The lower run of the conveyor belt running around the lower press plate of a press layer correspondingly runs underneath the upper press plate of a further press layer situated below it, running through this layer. If an active belt control is used, the asymmetrical tensions in the conveyor belt mean that one side of the belt sags while the other side is tensioned. Such a sagging naturally disturbs the transport of the workpiece into and out of the press layer situated underneath, and can even result in the production of rejects if workpieces that are to be processed are streaked during conveying by a sagging lower belt side. This problem can even completely prevent the construction of multi-layer laminating presses having longer pressing chambers and correspondingly higher throughput, because the belt sags would in this case become too great.

### SUMMARY

Against this background, the present invention is based on the object of providing a method for carrying out a belt run correction in a conveyor belt of a press of the type noted above, as well as a press having a belt run correction system, with which, or in which, the belt run correction can take place more simply and more efficiently and with lower stress on the belt.

This object is achieved by a method as well as by a press according to the invention.

Preferred developments of the method according to the present invention as well as the press according to the present invention are described in detail below and in the claims.

According to the present invention, in order to carry out a belt run correction, the at least one deflection roller that is present is capable of being moved axially, i.e. transverse to the direction of the transport movement of the conveyor belt.

Because the horizontal displacement of the conveyor belt that is to be corrected by the belt run correction system is ultimately nothing other than a gradual shifting of the axial position of the conveyor belt on the deflection roller, such a displacement can be corrected by axial movement of the deflection roller without having (as was previously the case) to tension the tensioning device asymmetrically or at one side. Rather, the tensioning device can advantageously provide a belt tensioning exclusively in parallel and therefore uniform fashion, which need only suffice to ensure the slippage-free driving of the conveyor belt and the disturbance-free conveying in and out of the workpieces. Higher tensions at one side for the correction of the belt run no longer necessarily have to be planned. As a consequence, this also means that according to the present invention the conveyor belt can be made of materials that would not withstand the high tensions at one side used as a standard until now for the belt run correction, but that are more economical and/or better suited for their intended use.

The axial movability according to the present invention of the deflection roller enables various designs for the monitoring and correction of the run of the conveyor belt. One of these possibilities is to respond in real time to a displacement of the conveyor belt with an axial movement of the deflection roller counteracting the displacement of the conveyor belt. A resetting of the deflection roller into a neutral position can then preferably take place while the press layer is closed, when the conveyor belt is clamped between the upper and the lower press plate. In this state, an axial movement causes a shifting of the surface of the deflection roller relative to the conveyor belt, such that the position of the conveyor belt on the deflection roller is then also again moved back to the neutral position.

The shifting relative to one another of the deflection roller and the conveyor belt can also easily be accomplished if the conveyor belt is relaxed and the friction between the conveyor belt and the deflection roller that is to be moved is as a result significantly reduced.

If the conveyor belt is both relaxed and also clamped in the closed press layer, as is the case for example in laminating presses, an axial movement of the deflection roller having the goal of changing the position of the conveyor belt on the deflection roller can be carried out particularly efficiently, because in this state the conveyor belt then no longer lies against the deflection roller, but rather forms a loose loop around it.

The above-described active real-time controlling of the axial movement of the deflection roller according to the present invention, corresponding to the momentary horizontal displacement of the conveyor belt, if warranted and preferably with resetting movements as needed of the deflection roller into a neutral position with shifting of the position of the conveyor belt on the deflection roller, ensures a maintenance of the conveyor belt in its track in the press layer that is more or less precise at all times. On the other hand, such a real-time controlling is fairly expensive.

Therefore, in the context of the present invention it is preferred, not to compensate a horizontal displacement of the conveyor belt in real time by an axial countermovement of the axially movable deflection roller, but rather to permit a displacement up to a threshold value—preferably to be detected by belt edge sensors—and to carry out a belt run correction only when the conveyor belt has next come to a standstill, by axially displacing the axially movable deflection roller by a preset value, which can correspond approximately to the threshold value of the belt displacement, in order to shift the position of the conveyor belt on the deflection roller, preferably to an approximately centered position. When the transport movement of the conveyor belt is restarted, the axial displacement of the deflection roller can then be undone by axially moving the deflection roller back into a neutral position, so that the conveyor belt is also carried along back into the neutral position and the displacement of the conveyor belt is corrected. Such a belt run correction can be carried out by very simple control means, namely preset axial movements of the deflection roller and belt edge sensors, and this approach advantageously always requires action only when the threshold value for a displacement of the conveyor belt has been exceeded, so that a correction is required.

As described above in connection with the active controlling of an axial movement of the deflection roller, here as well it is very advantageous to carry out the axial displacement of the deflection roller relative to the conveyor belt while the conveyor belt is relaxed, or is clamped in the closed press layer, or, particularly preferably, when it is clamped and relaxed.

This is because under these conditions an axial displacement between the deflection roller and the conveyor belt can be brought about particularly easily.

In the context of the present invention, the axial movement of the axially movable deflection roller can take place using electrical, pneumatic, or hydraulic actuating drives. This is realized in particularly simple and robust fashion if the axially movable deflection roller is moved elastically under spring action into its axial rest position, for example by mechanical helical springs, while when there is a controlling of an adjusting drive, which is preferably actuated fluidically, i.e. pneumatically or hydraulically, the above-mentioned axial displacement of the deflection roller is caused in the desired direction from its axial rest position. Thus, for example, if a belt edge sensor detects that the conveyor belt has exceeded a threshold value for a lateral displacement, the system can wait until the conveyor belt is standing still, preferably both relaxed and clamped in the press layer, whereupon the axial adjusting drive is then activated, which moves the deflection roller axially in the direction of the detected displacement of the conveyor belt. This results in a shift of position between the deflection roller and the conveyor belt. After the opening of the press and tensioning of the conveyor belt, and after starting up of the transport movement of the conveyor belt, the axial adjusting drive of the deflection roller is no longer driven to operate, so that this roller gradually moves into its axial rest position due to the spring-elastic resetting force, and carries the conveyor belt along with it into this position.

On the basis of this exemplary description of a possibility of realizing the method according to the present invention, it is clear that a belt run correction is carried out only as needed, and above all requires no additional cycle time, i.e. the working cycle of the press is not made longer.

### BRIEF DESCRIPTION OF THE DRAWINGS

An exemplary embodiment of a press according to the present invention is described and explained in more detail below on the basis of the accompanying drawings, with description also of preferred developments of the present invention.

FIG. 1 is a schematic lateral representation of a multi-layer press ready to be loaded or unloaded;

FIG. 2 is a schematic front view of a part of a press layer of the press of FIG. 1, in three different method steps a, b, and c;

FIG. 3 is a schematic half-sectional representation of an axially displaceable deflection roller in a first embodiment, at three different method time points a, b, and c;

FIG. 4 is a schematic half-sectional representation of a deflecting drum and a second embodiment, at two different method time points a and b.

### DETAILED DESCRIPTION OF THE PREFERRED EMBODIMENTS

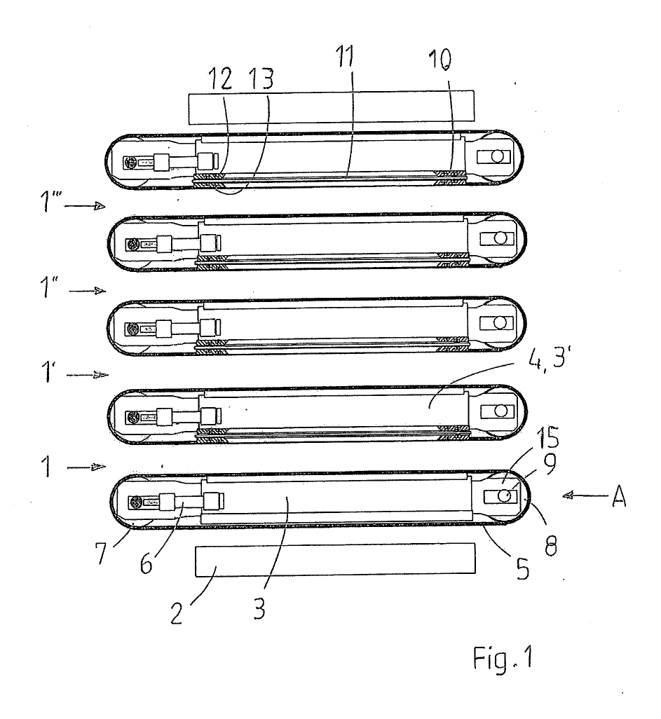

FIG. 1 shows, in a schematic lateral representation, a press having a total of four press layers 1, 1′, 1″, and 1′″, that can be vertically brought together and moved apart from one another in a press frame 2. Each press layer 1-1′″ is made up of a lower press plate 3 and an upper press plate 4, and the construction will be described with reference to one press layer 1′. A conveyor belt 5 runs around lower press plate 3 in order to load and unload the press layer 1. A tensioning device 6, made up essentially of a pneumatic piston-cylinder unit attached to the one hand to the lower press plate 3 and on the other hand to the axle of a deflection roller 7 of conveyor belt 5, ensures that conveyor belt 5 runs under tension about deflection roller 7 and about a drive roller 8 attached in a fixed position to the oppositely situated end face of lower press plate 3, with the drive roller also being a deflection roller in the sense of the present description, in order to introduce a workpiece (not shown) into the press layer 1 or to convey said workpiece out of the press layer 1.

The present exemplary embodiment of a multi-layer press realized according to the present invention is a laminating press for laminating photovoltaic modules. Correspondingly, each of the upper press plates 4, which is simultaneously the lower press plate 3′ of press layer 1′ respectively situated over it, bears on its lower side a double frame 10 in which a flexible membrane 11 is clamped. Together with the adjoining press plates 3, 4, double frame 10 forms, with upper seals 12 and lower seals 13, which respectively seal against lower press plate 3 or upper press plate 4, a vacuum chamber having channels (not shown) for evacuating and/or pressure-charging a product chamber formed underneath membrane 11 and a pressure chamber formed above membrane 11.

FIG. 1 shows the open press ready for loading with workpieces. The conveyor belts 5 are symmetrically tensioned by their tensioning devices 6 only to such an extent that the friction of conveyor belts 5 on drive rollers 8 is sufficient to execute a defined transport movement for introducing the workpieces. Due to the symmetrical tension of conveyor belts 5, none of them sag at the left side or at the right side, so that the path of introduction for the workpieces is free in all press layers 1.

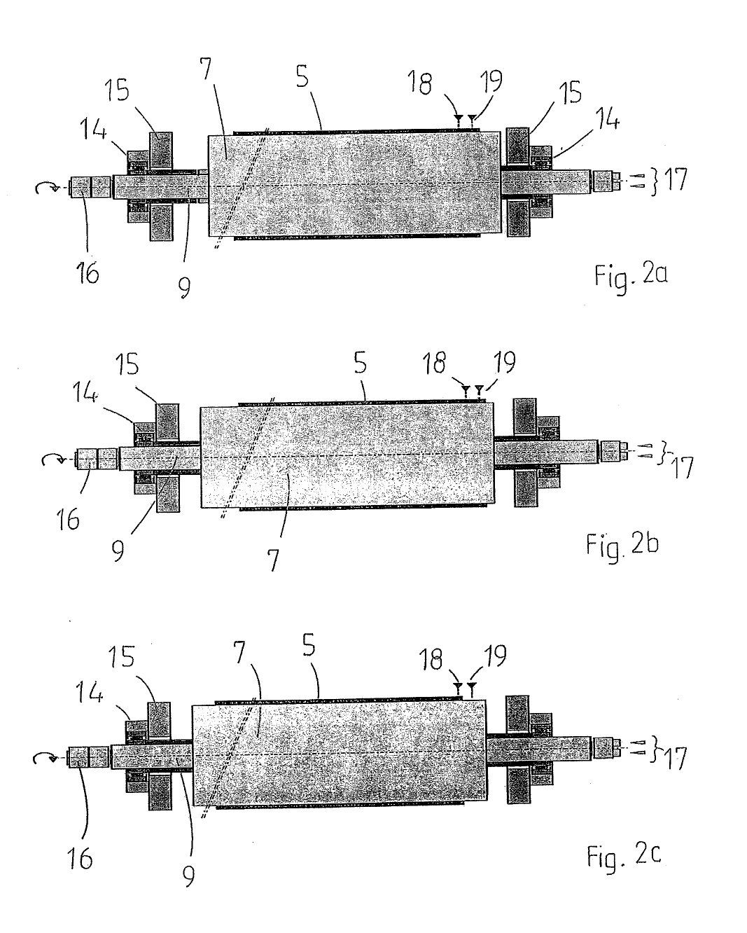

FIGS. 2a, 2b, and 2c show a top view, in the direction of arrow A in FIG. 1, of lower press plate 3 of lower press layer 1, again in a schematic representation, in three different phases during the execution of the belt run correction according to the present invention.

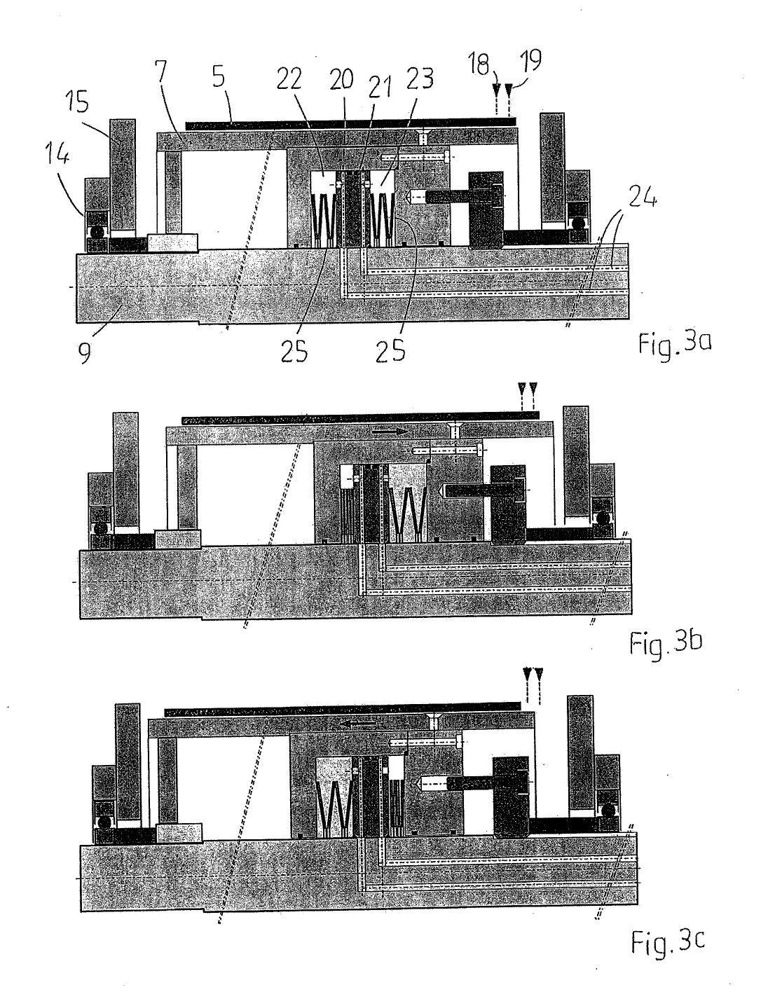

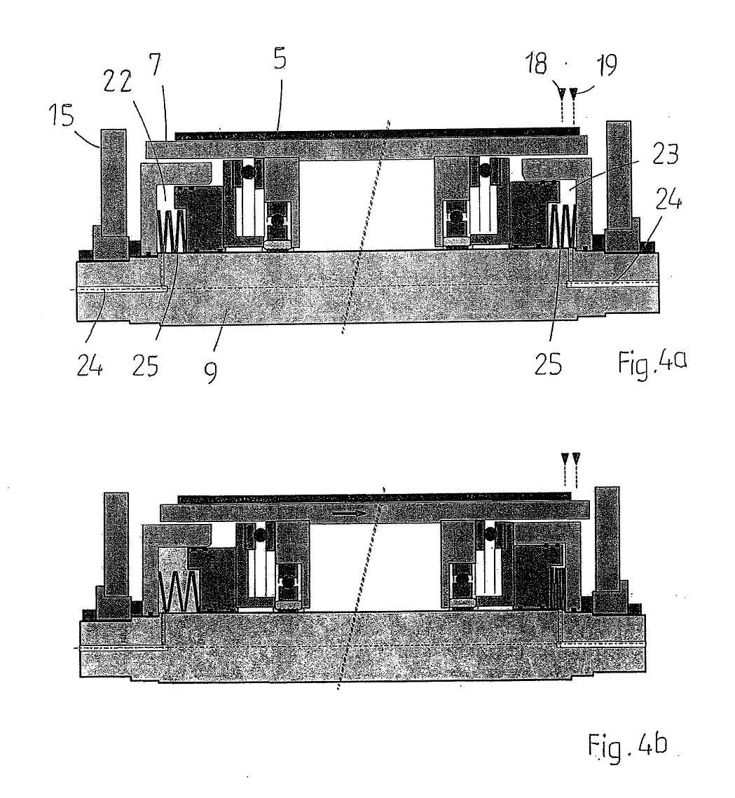

Here it is shown that the deflection roller 7 is seated in axially movable fashion on an axle 9, which in turn is fastened in axially immovable fashion by bearings 14 in an axle receptacle 15 of lower press plate 3. At one end of axle 9 there is situated a rotary drive 16 for producing the transport movement of conveyor belt 5, which runs about the deflection roller 7, making this roller a drive roller. At the other end of the axle 9 there is situated a pressurized air rotary feed connection 17 for supplying an adjusting drive for the axial movement of the deflection roller 7 on its axle 9. FIGS. 3 and 4 illustrate possible exemplary embodiments of such an actuating drive.

Two belt edge sensors 18 and 19 are indicated, which detect a horizontal displacement of conveyor belt 5 relative to lower press plate 3. Such a horizontal displacement of conveyor belt 5 has already taken place in FIG. 2a; the conveyor belt 5 is no longer wrapped around deflection roller 7 in the center, but rather is horizontally displaced toward the right. Here, the deflection roller 7 is situated in a centered axial rest position. In the situation of FIG. 2a, the belt edge sensors 18 and 19 report the displacement that has taken place of conveyor belt 5; because both belt edge sensors 18, 19 detect a conveyor belt, the situation here is that of a displacement to the right.

After the transport movement of conveyor belt 5 has been terminated, tensioning device 6 loosened, and the press closed, as shown in FIG. 2b the actuating drive (not shown) inside the axle 9 is then controlled in such a way that it displaces the deflection roller 7 axially to the right. Because on the one hand conveyor belt 5 is clamped in the closed press layer, and on the other hand conveyor belt 5 forms a relaxed loose loop about deflection roller 7 due to deactivated tensioning device 6, the axial movement of deflection roller 7, as shown in FIG. 2b, has caused a displacement of the axial position of conveyor belt 5 on deflection roller 7, into the original centered situation of conveyor belt 5 on deflection roller 7. However, this axial displacement of deflection roller 7 has not yet changed the horizontal position of conveyor belt 5 relative to press layer 1. Now, only conveyor belt 5 and deflection roller 7 are simultaneously laterally displaced.

Therefore, as FIG. 2c shows, when the transport movement of conveyor belt 5 is restarted deflection roller 7 is moved back into its centered axial rest position, carrying conveyor belt 5 along with it, so that this belt is also again in a centered rest position relative to the press layer. This terminates the belt run correction.

FIG. 2c moreover shows that the right edge of conveyor belt 5 is now situated between the two belt edge sensors 18, 19, and is thus within the specified tolerance for a displacement of conveyor belt 5 relative to press layer 1. If left belt edge sensor 18 and right belt edge sensor 19 were no longer to detect conveyor belt 5, a belt run correction would be executed conversely, by axially displacing deflection roller 7 not to the right but to the left, with conveyor belt 5 at a standstill.

In order to enable execution of a belt run correction, it is advantageous, but not compulsory, for the deflection rollers 7 at both end faces of lower press plate 3, i.e. not only drive roller 8 shown in FIG. 2 but also entrained deflection roller 7, to be equally axially displaceable.

FIGS. 3a, 3b, and 3c show a schematic representation of the “inner workings” of the deflection roller 7 shown in FIGS. 2a, 2b, and 2c, again in those phases of the method also shown in FIG. 2. As can be seen, inside the deflection roller 7 there is situated an actuating drive for the axial displacement of the deflection roller 7, made up of an axially displaceable pressure cylinder 20 fastened to the deflection roller 7, whose pressure chamber is divided, by a disk 21 fastened in axially immobile fashion to the axle 9, into a left pressure chamber 22 and a right pressure chamber 23. By means of two pressure channels 24, the two pressure chambers 22, 23 can be charged with a pressure medium, here pressurized air. A mechanical compression spring 25 is present in each of the pressure chambers 22, 23, which bring the pressure cylinder 20 into its axial rest position shown in FIG. 3a via an elastic resetting force, as soon as the two pressure chambers 22, 23 are not charged with pressurized fluid.

FIG. 3a shows the phase already shown in FIG. 2a, in which the deflection roller 7, and with it the actuating drive, is situated in its axial rest position, while the conveyor belt 5, detected by the belt edge sensors 18, 19, has moved to the right.

In the phase shown in FIG. 3b, the right pressure chamber 23 of the pressure cylinder 20 is charged with pressurized air, while the air from the left pressure chamber 22 can freely escape via the associated pressure channel 24. Due to this, the pressure cylinder 20, and with it the deflection roller 7, has carried out an axial displacement to the right, causing the conveyor belt 5 to return to a centered position on the deflection roller 7.

FIG. 3c shows the converse situation: here, the left pressure chamber 22 was charged with pressurized air while the right pressure chamber 23 was set to no pressure, so that the deflection roller 7 has carried out an axial displacement to the left. If the two pressure chambers 22, 23 of pressure cylinder 20 are now set to be pressure-free, the two compression springs 25 press the pressure cylinder 20 gradually back into its centered axial rest position, as shown in FIG. 3a.

Finally, FIGS. 4a and 4b show a different realization of the axial actuating drive for the deflection roller 7; FIG. 4a shows the deflection roller 7 in an axial rest position, while in FIG. 4b the deflection roller 7 has been displaced to the right. Here, the left pressure chamber 22 and right pressure chamber 23 are placed at the end faces of deflection roller 7 and are therefore separated from one another, but each of them contains a compression spring 25. The manner of operation of this actuating drive is the same as that shown in FIGS. 3a, 3b, and 3c, so that reference is made to the description given there.

Finally, it is to be noted that the axial actuating drive may also be realized in a completely different manner according to the demands and local conditions, for example as an electrical actuating motor or spindle drive, or a pneumatic pushrod drive or the like.

1. A method for carrying out a belt run correction for a conveyor belt (5) of a press having at least one press layer (1, 1′, 1″, 1′″) comprising a lower press plate (3) and an upper press plate (4) that can be moved relative to one another in order to open and close the press layer (1), a conveyor belt (5) that runs around the lower press plate (3) for conveying a workpiece into and out of the press layer (1), and at least one deflection roller (7, 8) for the conveyor belt (5), situated at an end face of the lower press plate (3), that deflects the conveyor belt (5) from an upper side to a lower side of the lower press plate (3) and vice versa, and that is provided with a tension device (6) for tensioning and relaxing the conveyor belt (5), the deflection roller (7) being movable by the tensioning device (6) relative to the lower press plate (3), the method comprising:
in order to carry out a belt run correction, moving the deflection roller (7, 8) axially as needed.

2. The method as recited in claim 1, further comprising
carrying out a part of the axial movement of the deflection roller (7, 8) in a relaxed state of the conveyor belt (5), by shifting the deflection roller (7, 8) and the conveyor belt (5) relative to one another, thereby changing a position of the conveyor belt (5) on the deflection roller (7, 8).

3. The method as recited in claim 2, further comprising
carrying out the belt run correction by first relaxing the conveyor belt (5), and then axially moving the deflection roller (7, 8) in order to shift the deflection roller (7, 8) and the conveyor belt (5) relative to one another, thereby changing the position of the conveyor belt (5) on the deflection roller (7, 8), and then tensioning the conveyor belt (5) and axially moving the deflection roller (7, 8) back at least one of before or during a transport movement of the conveyor belt (5).

4. The method as recited in claim 1, wherein
in order to shift the deflection roller (7, 8) and the conveyor belt (5) relative to one another, thereby changing the position of the conveyor belt (5) on the deflection roller (7, 8) the axial movement of the deflection roller (7, 8) takes place in a closed state of the press layer (1), with the conveyor belt (5) being clamped between the lower and the upper press plate (3, 4).

5. The method as recited in claim 1, wherein
a displacement of the conveyor belt (5) during its transport movement is compensated at least partly by an axial movement of the deflection roller (7, 8).

6. A press, comprising at least one press layer (1, 1′, 1″,1′″) having a lower press plate (3) and an upper press plate (4) that can be moved relative to one another in order to open and close the press layer (1), a conveyor belt (5) that runs around the lower press plate (3) for conveying a workpiece into and out of the press layer (1), at least one deflection roller (7, 8) for the conveyor belt, situated at an end face of the lower press plate (3), that deflects the conveyor belt (5) from an upper side to a lower side of the lower press plate (3) and vice versa, a tension device (6) for tensioning and relaxing the conveyor belt (5), the deflection roller (7) is movable by the tensioning device (6) relative to the lower press plate (3), and the deflection roller (7, 8) is made axially movable in order to carry out a belt run correction of the conveyor belt (5).

7. The press as recited in claim 6, wherein the tensioning device (6) and the deflection roller (7, 8) are correlated in their movements in such a way that a part of an axial movement of the deflection roller (7, 8) is carried out in a relaxed state of the conveyor belt (5) in order to shift the deflection roller (7, 8) and the conveyor belt (5) relative to one another and thereby to change a position of the conveyor belt (5) on the deflection roller (7, 8).

8. The press as recited in claim 7, wherein in a closed state of the press layer (1), the conveyor belt (5) is clamped between the lower and the upper press plate (3, 4).

9. The press as recited in claim 6, wherein the deflection roller (7, 8) is provided with a fluidic drive (20, 21) or with an electromechanical spindle drive in order to produce an axial movement.

10. The press as recited in claim 6, wherein a spring-elastic resetting force (25) is applied to the deflection roller (7, 8), for moving the deflection roller into an axial rest position.
